(19) United States
(12) Patent Application Publication
(10) Pub. No.: US 2006/0050745 A1
(43) Pub. Date: Mar. 9, 2006

(54) Method and system for generating ultrashort laser pulses

(76) Inventors: Eiichi Takahashi, Ibaraki (JP); Leonid Losev, Ibaraki (JP); Yuji Matsumoto, Ibaraki (JP); Yoshiro Owadano, Ibaraki (JP)

Correspondence Address: MORGAN LEWIS & BOCKIUS LLP, 1111 PENNSYLVANIA AVENUE NW, WASHINGTON, DC, 20004, US

(21) Appl. No.: 10/529,747

(22) PCT Filed: Sep. 30, 2003
(86) PCT No.: PCT/JP03/12524

§ 371 Date: Mar. 30, 2005

(30) Foreign Application Priority Data
Sep. 30, 2002 (JP) 2002-286116

(51) Int. Cl. H01S 3/30

(52) U.S. Cl. 372/5

(57) ABSTRACT

According to the invention, the wavelength of a laser pulse is once converted to another wavelength by using a nonlinear optical action. A ratio of the intensity at a temporal peak of a pulse to that at a front part thereof is increased. The converted laser light is reconverted by using a nonlinear optical action in such a way as to have an initial wavelength again. Thus, simultaneously with extremely enhancing the contrast at the front part of the pulse, the amplification thereof by a used laser amplifier is enabled. Saturation amplification is then performed on the pulse to thereby form ultrashort pulses. When the generation of ultrashort excimer laser pulses is performed, the generation thereof can be performed without using a costly mode-locked laser.

### TECHNICAL FIELD

This invention relates to a laser technique for use in laser processing, in laser spectroscopy, in cluster generation, and in laser production of thin film.

### BACKGROUND ART

To generate ultrashort excimer laser pulses of pulsewidths in the picosecond or femtosecond range, generally, a mode-locking oscillator, an amplifier, and wavelength conversion have been used by being combined with one another. This mode locking method is a technique of generating a train of ultrashort pulses by causing longitudinal modes of a laser resonator through the use of means, such as a supersaturated dye and Kerr effect, to be coherent in phase. Moreover, because an output of the oscillator itself is small, practically, it is necessary to increase the output thereof by using an amplifier. Furthermore, because the operating wavelength of such an oscillator is in the range from an infrared region to a visible region, the conversion of the operating wavelength to an ultraviolet excimer laser wavelength is needed.

The oscillator requires a continuously oscillating strong pump laser. Chirped-pulse amplification is employed in an amplification system. Additionally, higher-order wavelength conversion is needed. Thus, inevitably, the system has become complex and costly.

Attempts have been made to make the excimer laser itself perform a mode locking operation, and to an output of a long-pulse excimer laser by stimulated-scattering. At any of the attempts, only the generation of long pulses ranging from several tens ps to several hundreds ps has been achieved (see Patent Documents 1 to 3 and Non-Patent Documents 1 to 3 described hereinbelow).
[Patent Document 1]
   JP-A-Hei6-21550
[Patent Document 2]
   JP-A-2000-2804
[Patent Document 3]
   JP-A-2002-25949
[Non-Patent Document 1]
   D. E. Spence, P. N. Kean, and W. Sibbett: Optics Letters, No. 16, 1991, p. 42
[Non-Patent Document 2]
   D. T. Hon: Optics. Letters, Vol. 5, No. 12, 1980, p. 516
[Non-Patent Document 3]
   O. L. Bourne, and J. Alcock: Applied Physics B, No. 4, 1985, p. 181

### DISCLOSURE OF INVENTION

An object of the invention is to perform the generation of ultrashort excimer laser pulses without using a costly mode-locked laser when the generation thereof is performed.

According to the invention, the wavelength of a laser pulse is once converted to another wavelength by using a nonlinear optical action. A ratio of the intensity at a temporal peak of a pulse to that at a front part thereof is increased. The converted laser light is reconverted by using a nonlinear optical action in such a way as to have an initial wavelength again. Thus, simultaneously with extremely enhancing the contrast at the front part of the pulse, the amplification thereof by a used laser amplifier is enabled. Saturation amplification is then performed on the pulse to thereby form ultrashort pulses.

### BRIEF DESCRIPTION OF DRAWINGS

FIG. 1 is a conceptual view illustrating an equipment arrangement.

FIG. 2 is a waveform chart illustrating waveforms of output pulses of a discharge excitation KrF laser and so on, which are measured by using a photo multiplier tube.

FIG. 3 is a waveform chart illustrating the waveforms of pulses wavelength-converted by backward Raman scattering, which is obtained with a high time resolution by using a streak camera.

FIG. 4 is a graph illustrating the spectra of a pulse wavelength-converted by backward Raman scattering and a pulse generated by performing a four-wave mixing process.

FIG. 5 is a graph illustrating a result of measurement of the auto-correlation pulse width of a finally amplified output pulse width.

### BEST MODE FOR CARRYING OUT THE INVENTION

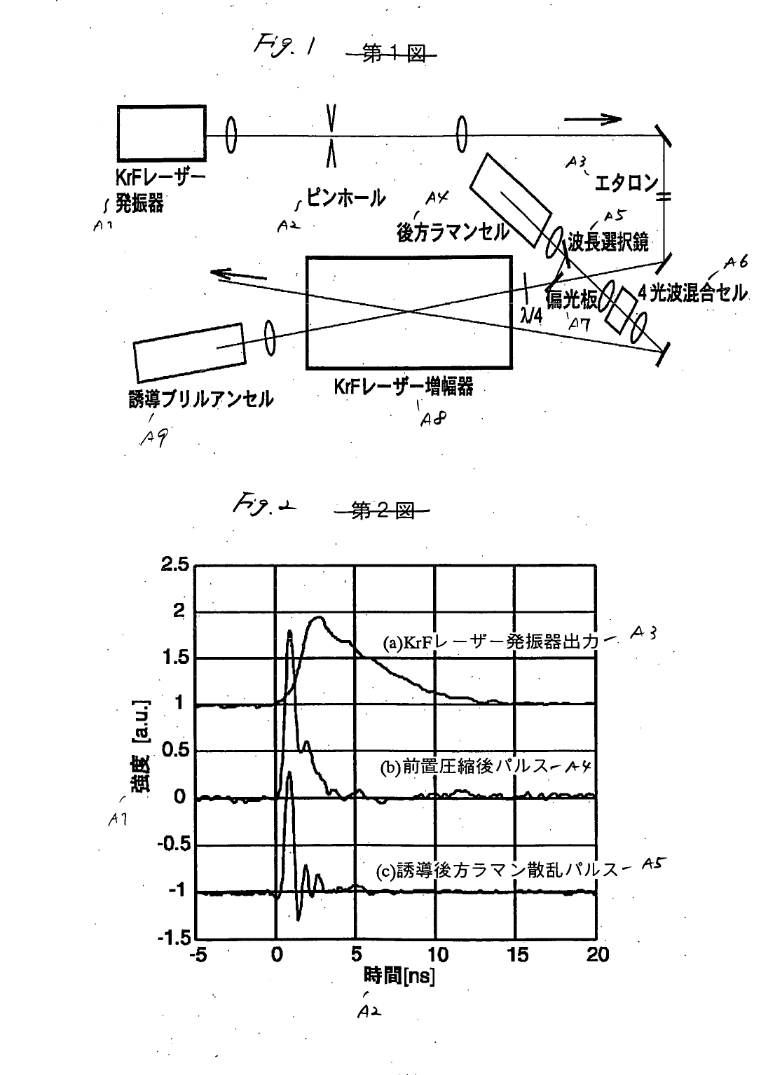

FIG. 1 is a view illustrating the configuration of an apparatus embodying the invention. The apparatus comprises a preparing portion for improving the quality of a laser pulse so as to embody the invention, and also comprises a main portion for carrying out the invention.

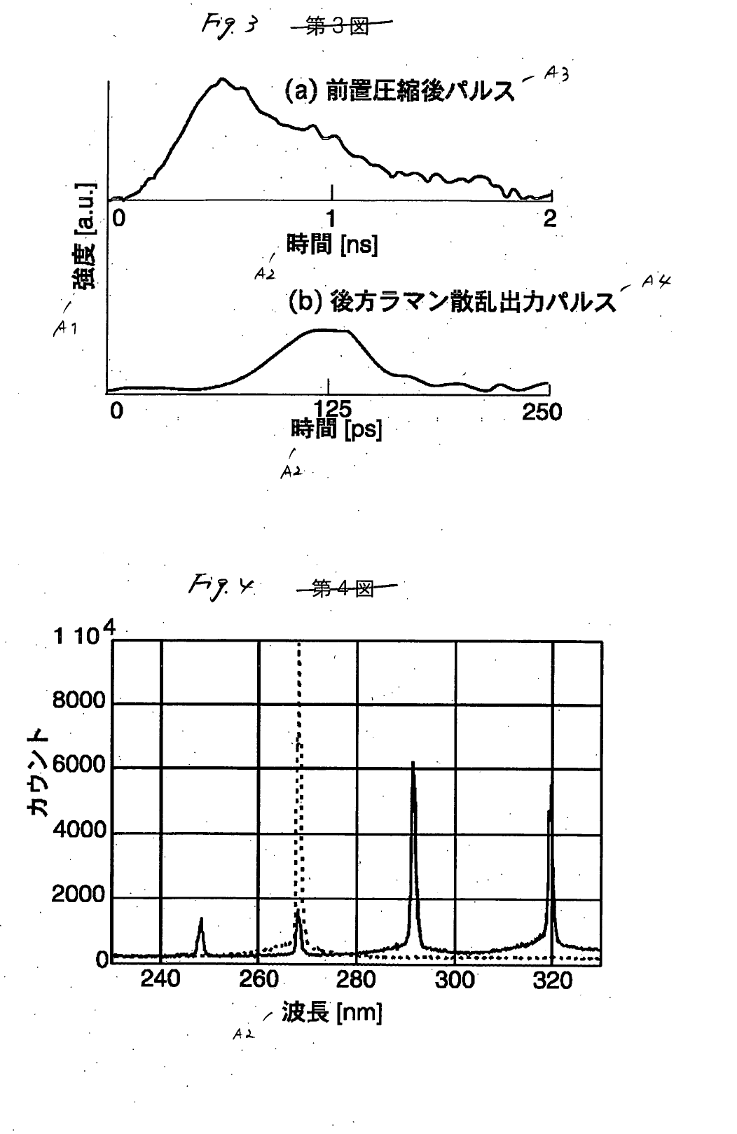

First, regarding the preparing portion, a laser pulse (see the waveform of a pulse shown in FIG. 2(a)) which is outputted from a krypton-fluorine (KrF) excimer laser oscillator and has a half-width of about 5 nanoseconds, is converged by a lens and passed through a pinhole. Consequently, a component of laser light, which is inferior in the focusing property, cannot pass through the pinhole. Thus, the spatial quality of the laser light is improved. Generally, this is called a spatial filter. The diverging laser light having passed through the pinhole is collimated by using a lens again. Subsequently, the laser light is passed through an etalon to thereby enhance the monochromaticity thereof. This is performed so as to increase the gain of stimulated scattering to be used after this. The laser light, whose intensity is reduced by these operations, is amplified by being passed through a KrF laser amplifier. At this amplification, a weak laser pulse having a long pulse width is amplified, so that the amplified laser pulse is not brought into a saturated state. Thus, after amplified, the waveform of the pulse does not largely change. This is because of the fact that the waveform of the pulse extremely depends upon the input waveform thereof and may broaden or become sharp over time in a saturation-amplified state, and that however, when the pulse is not in the saturation-amplified state, fundamentally, the intensity thereof is multiplied by a gain at each moment.

To realize an efficient conversion utilizing stimulated Raman scattering, which corresponds to the wavelength conversion to be first performed according to the invention, laser light having a pulse width of 5 nanoseconds, which is outputted by the oscillator, is preliminarily pulse-compressed by stimulated Brillouin scattering into a pulse having a pulse width of about 300 picoseconds. The previously amplified laser pulse is made to be incident upon the stimulated Brillouin cell by being simultaneously converged thereto. In the apparatus, a (λ/4)-wavelength plate and a polarizer are preliminarily provided so that this stimulated Brillouin scattering light and the incident laser light can be separated from each other. The stimulated Brillouin cell is filled with carbon-fluorine-based liquid. Scattering light generated in the vicinity of a focal point grows up while propagating through an optical path, upon which the incident light has been previously incident, in an opposed manner. Pulse-compression effect acts upon the scattering laser light pulse, which has propagated therethrough in an opposed manner, so that the width of the scattering laser light pulse becomes shorter than the width of the incident laser light. The waveform of the pulse, which is measured by using a photo multiplier tube, is shown in (b) of FIG. 2. The waveform thereof, which is measured by a streak camera with a higher time resolution, is shown in (a) of FIG. 3. Pulses formed by the stimulated Brillouin scattering are generated due to sound-wave scattering. The wavelength of the scattering laser light is almost equal to that of the incident laser light. Thus, the scanning laser light can be amplified again by the KrF laser.

Laser light outputted from the aforementioned preparing portion is provided as a pulse, which is improved in the focusing property and the monochromaticity thereof and has a duration of about 300 picoseconds. The main portion for carrying out the invention improves the contrast of a front part of this pulse and saturation-amplifies and forms ultrashort pulses. The necessity for such a preparing portion depends upon the width of necessary final output laser pulses and the characteristics of individual lasers. Thus, the portion may have various configurations. For example, the aforementioned pulse can be obtained by using an electro-optic device.

Generally, the wavelength conversion uses a nonlinear response of a medium with which laser light rays interact. Consequently, the ratio of the intensity of the peak to the intensity of the front or rear part of a laser pulse, that is, the contrast thereof can be increased, and thus improved. In this embodiment, input laser light is converted into laser light having a longer wavelength by performing a nonlinear stimulated backward Raman scattering process based on the third-order nonlinearity of the medium. The scattering laser light formed by the stimulated Raman scattering is the scattering light due to the polarization of molecules. The wavelength thereof is largely shifted from that of the incident laser light. In this embodiment, the wavelength of an output of the oscillator is 248 nm. This output is made by using the lens to be converged and incident on the cell, which is filled with a methane medium. Consequently, longer-wavelength laser light having a wavelength of 268 nm is generated by the stimulated Raman scattering so that this laser light propagates therethrough in an opposed manner. The incident laser light and the generated Raman scattering light are separated by a wavelength selection mirror from each other. Further, similarly, the contrast can be improved by generating second harmonic laser light using second-order nonlinearity.

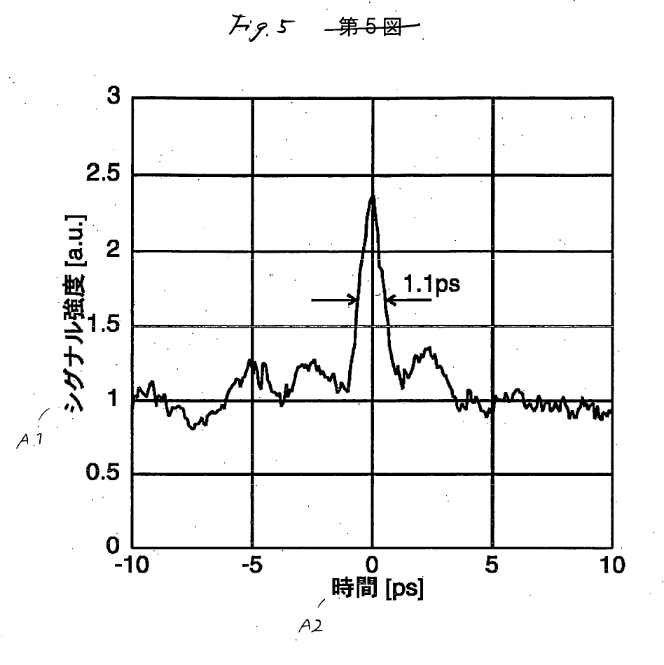

The waveform of laser light converted by this stimulated Raman scattering in such a way as to have a longer wavelength is shown in (b) of FIG. 3. The spectra of the laser light are indicated by a dashed curve in FIG. 4. The medium is arranged so that light is backwardly scattered by this stimulated Raman scattering. Thus, this stimulated Raman scattering has a pulse compression effect, so that the width of an output pulse is 60 picoseconds. It is seen therefrom that the spectra indicated by the dashed curve does not include a component having a wavelength of 248 nm, which is the wavelength of the light originally outputted from the KrF laser.

Generally, the wavelength of the wavelength-converted light having high contrast is outside the range of wavelengths of light that the laser oscillator can amplify. The reconversion of converting this light to light having the initial wavelength by utilizing the response of the nonlinear medium is performed. In this embodiment, the scattered laser light having a wavelength of 268 nm is converted back to light having a wavelength of 248 nm by employing the four-wave mixing process using the same methane medium as that used for the aforementioned stimulated Raman scattering. Practically, the scattered laser light is incident on the cell by being converged thereon. The laser light having a wavelength of 268 nm and light, which is generated therefrom and having a wavelength of 291 nm, parametrically interact with the nonlinear Raman medium to thereby form light having a wavelength of 248 nm. This process is also based on the third-order nonlinearity of the medium and thus contributes to the improved contrast. The spectra of output light of this embodiment are indicated by a solid curve in FIG. 4. It is seen therefrom that a component having a wavelength of 248 nm, which is the initial wavelength of output light of the KrF laser oscillator, is formed together with Stokes light having a longer wavelength. These processes are performed in a rise part of the pulse, which is in a transient state in a time range that is shorter than the transverse relaxation time of the methane medium, that is, about 30 ps. Thus, the rise part of the generated light is a very steep part.

When the laser light having a very high contrast, which is formed in this way, is saturation-amplified by a laser amplifier, a laser pulse having a short pulse width is formed at a rise portion thereof. This saturation amplification is defined as the amplification of a laser pulse having an energy density that is higher than a saturated energy density inherent in each of individual lasers.

FIG. 5 shows a result of measurement of the auto-correlation pulse width, which is a result of measurement of an output pulse saturation—amplified by the KrF laser amplifier. This shows that an ultrashort pulse having a pulse width of 1.1 picoseconds is formed. The generation of such an extremely short pulse is realized by the saturation amplification of a rise part of a KrF laser wavelength component of light outputted from a four-wave mixing cell, because such a rise part has a very high contrast. Theoretically, the pulse width has a value limited by the spectral band width of the laser. In the case of using the KrF excimer laser in the embodiment, the pulse width is about 100 femtoseconds.

Although a KrF excimer laser is used therein, the laser according to the invention is not limited to the excimer laser. As long as a laser has a damage threshold value for high laser power, which enables the saturation amplification, such a laser can be used in the method and the apparatus of the invention.

### INDUSTRIAL APPLICABILITY

When the generation of ultrashort excimer laser pulses is performed, the generation thereof can be performed without using a costly mode-locked laser.

1. A method for generating an ultrashort pulse, comprising the steps of:
converting a laser pulse once into a laser pulse having another wavelength;
reconverting the laser pulse having another wavelength into a laser pulse having an initial wavelength to improve the contrast at a front part of the pulse; and
amplifying the pulse by a laser to generate an ultrashort pulse.

2. The method for generating an ultrashort pulse according to claim 1, wherein the laser is an excimer laser.

3. The method for generating an ultrashort pulse according to claim 2,
wherein the laser pulse is converted into a pulse having another wavelength by performing stimulated Raman scattering; and
the reconversion of the pulse to a pulse having the initial wavelength is performed by performing four-wave mixing.

4. The method for generating an ultrashort pulse according to claim 1, wherein the amplification of the pulse is saturation amplification.

5. An ultrashort pulse generating apparatus, comprising:
a laser;
a (λ/4)-wavelength plate and
a polarizer, wherein
a laser pulse is once converted into a laser pulse having another wavelength;
the laser pulse having another wavelength is reconverted into a laser pulse having an initial wavelength to improve the contrast at a front part of the pulse; and
the pulse is amplified by a laser to generate an ultrashort pulse.

6. The ultrashort pulse generating apparatus according to claim 5, wherein the laser is an excimer laser.

7. The ultrashort pulse generating apparatus according to claim 5, wherein
the laser pulse is converted into a pulse having another wavelength by performing stimulated Raman scattering; and
the reconversion of the pulse to a pulse having the initial wavelength is performed by performing four-wave mixing.

8. The ultrashort pulse generating apparatus according to claim 5, wherein the amplification of the pulse is saturation amplification.
